(19) United States
(12) Patent Application Publication
(10) Pub. No.: US 2003/0193260 A1
(43) Pub. Date: Oct. 16, 2003

(54) Composite power metal stator sleeve

(76) Inventors: Frederick B. Reiter JR., Cicero, IN (US); Brian J. Maskew, Noblesville, IN (US); Ronald J. Krefta, Noblesville, IN (US)

Correspondence Address: MARGARET A. DOBROWITSKY, DELPHI TECHNOLOGIES, INC., Legal Staff, Mail Code : 480-414-420, P.O. Box 5052, Troy, MI, 48007-5052, US

(21) Appl. No.: 10/123,501

(22) Filed: Apr. 16, 2002

(51) Int. Cl. H02K 1/06; H02K 1/12

(52) U.S. Cl. 310/217; 310/254

(57) ABSTRACT

A composite powder metal stator sleeve for placing adjacent the tip-less teeth of a conventional stator core to form a stator assembly in an electric machine. The sleeve includes alternating tooth tip-shaped magnetically conducting segments of sintered ferromagnetic powder metal and magnetically non-conducting segments of sintered non-ferromagnetic powder metal. A stator assembly is also provided in which a stator core, for example, of stamped laminations, includes radially extending tip-less teeth, and the composite sleeve of the present invention surrounds and contacts the teeth of the stator core to form tips extending from the teeth and topsticks/slot wedges between the tips. There is further provided alternative methods of making an annular composite powder metal stator sleeve of the present invention, including a compaction-sintering method, an injection molding method, and a sinterbonding method.

### FIELD OF THE INVENTION

This invention relates generally to electric machines, and more particularly, to the manufacture of stator sleeves for use with stators and stator cores in electric machines.

### BACKGROUND OF THE INVENTION

It is to be understood that the present invention is equally applicable in the context of generators as well as motors. However, to simplify the description that follows, reference to a motor should also be understood to include generators, and reference to an electric machine should be understood to include both motors and generators.

Alternating current generators and electric motors typically incorporate a fixed stator assembly for inductively producing magnetic fields that interact with an adjacent rotating component or rotor. A stator assembly incorporates a magnetic stator core fabricated traditionally from thin laminates of an iron-based material such as a silicon-iron alloy. Individual laminations are punched from flat sheets of the ferrous material using specialized dies with the required shape and number of slots and teeth. The individual laminations are coated with a thin insulating layer to reduce eddy current losses, carefully aligned in a stack, and secured to form a stator core. Conductors are wound in the slots to complete the stator assembly for incorporation into a generator or motor. Topsticks or slot wedges may also be added after the conductors are wound in the slots to enclose the winding in the slot. Most production electric machines incorporate side-extending tooth tips integrally fashioned during the stamping process. Some electric machines utilize fully open slots to increase the conductor content in the slot. However, fully open slots may result in excessive rotor losses due to relatively large air gap flux/reluctance variations caused by the low reluctance of the large slot opening as compared to the high reluctance of the body of the stator tooth. One option for maintaining open slots during the winding process followed by a methodology for providing tooth tips during machine operation involves forming the laminations such that the tooth tips extend into the air gap, and subsequently bending the tips into the proper position after winding of the conductors.

Stator cores have also been produced from an iron-based powder using conventional powder metallurgy techniques. A near-net shape, single piece green compact is produced by applying a large uniaxial pressure to compress a quantity of the powder that is dimensionally confined within a die. The die possesses a geometric shape with features that complement the desired features of the stator core. Stator cores formed from pure iron powder by conventional powder metallurgy techniques typically have a density of about 7.2 g/cm³ to about 7.3 g/cm³. An example of a stator core fabricated from an iron-based powder by conventional powder metallurgy techniques is disclosed in U.S. Pat. No. 4,947,065 issued to Ward et al.

Iron-based powder is a magnetic material that is subject to undesirable hysteresis losses and eddy current losses when it is exposed to a rapidly varying electromagnetic field. Thus, prior to compaction, the iron-based powder is coated with a dielectric material using one of a number of well-known processes. The dielectric coating electrically insulates individual particles of iron to minimize core losses due to eddy currents and hysteresis. Such coatings include thermoplastics, such as disclosed in U.S. Pat. No. 5,211,896 issued to Ward et al., iron phosphates, such as disclosed in U.S. Pat. No. 5,063,011 issued to Rutz et al., and alkali metal silicates, such as disclosed in U.S. Pat. No. 4,601,765 issued to Soileau et al.

In conventional powder metallurgy techniques, the compact may be sintered after compacting to develop metallurgical bonds by mass transfer under the influence of heat. However, subsequent thermal treatment of coated iron powder degrades the electrical insulating properties of the dielectric coating, particularly for a thermoplastic coating, and produces a stator core having unsatisfactory magnetic properties.

Stator cores of coated iron powder compacted by traditional powder metallurgy techniques have magnetic properties significantly inferior to those of a stator core constructed from stacked laminations, especially for low-frequency applications. More specifically, a stator core formed of iron-based powder will generally have lower saturation (flux capacity), a reduced permeability, and higher hysteresis losses than a comparable laminated stator core.

Powder metal manufacturing technologies that allow two or more powder metals to be bonded together to form a rotor core have been disclosed. The following co-pending patent applications are directed to composite powder metal electric machine rotor cores fabricated by a compaction-sinter process: U.S. patent application Ser. No. 09/970,230 filed on Oct. 3, 2001 and entitled “Manufacturing Method and Composite Powder Metal Rotor Assembly for Synchronous Reluctance Machine”; U.S. patent application Ser. No. 09/970,197 filed on Oct. 3, 2001 and entitled “Manufacturing Method And Composite Powder Metal Rotor Assembly For Induction Machine”; U.S. patent application Ser. No. 09/970,223 filed on Oct. 3, 2001 and entitled “Manufacturing Method And Composite Powder Metal Rotor Assembly For Surface Type Permanent Magnet Machine”; U.S. patent application Ser. No. 09/970,105 filed on Oct. 3, 2001 and entitled “Manufacturing Method And Composite Powder Metal Rotor Assembly For Circumferential Type Interior Permanent Magnet Machine”; and U.S. patent application Ser. No. 09/970,106 filed on Oct. 3, 2001 and entitled “Manufacturing Method And Composite Powder Metal Rotor Assembly For Spoke Type Interior Permanent Magnet Machine,” each of which is incorporated by reference herein in its entirety. Additionally, the following co-pending application is directed to composite powder metal electric machine rotor cores fabricated by metal injection molding: U.S. patent application Ser. No. 09/970,226 filed on Oct. 3, 2001 and entitled “Metal Injection Molding Multiple Dissimilar Materials To Form Composite Electric Machine Rotor And Rotor Sense Parts,” incorporated by reference herein in its entirety. Both the compaction-sinter process and the metal injecting molding process (as disclosed in the above-referenced patent applications) lead to advantages such as strong structural support and non-existent permeable flux leakage paths, and do provide an opportunity to manufacture a rotor core for an electric machine that costs less, spins faster, provides more output power, and is more efficient.

While improvements might be achievable by switching to powder metal stator cores, the current trend is to still use the conventional stamped and stacked laminations for the stator cores. A need thus exists for the continued use of conventional stator cores, but with modification to the stator assembly to achieve improved performance, such as low rotor core losses, larger copper packing factor, efficient flux paths and material strength.

### SUMMARY OF THE INVENTION

The present invention provides a composite powder metal stator sleeve for placing adjacent tip-less teeth of a conventional laminated stator core to form a stator assembly in an electric machine. The sleeve includes alternating magnetically conducting segments of sintered ferromagnetic (permeable) powder metal and magnetically non-conducting segments of sintered non-ferromagnetic (non-permeable) powder metal. There is also provided a stator assembly having a stator core of stamped laminations having tip-less teeth for placing adjacent a rotating component, and the stator sleeve of the present invention adjacent and contacting the tip-less teeth of the stator core to provide magnetically conducting (permeable) material over the stator teeth thereby incorporating stator tooth tips, and magnetically non-conducting (non-permeable) material in between the stator teeth to provide built-in topsticks/slot wedges of high material strength. In another embodiment of the present invention, a powder metal stator core having tip-less teeth is provided, and the stator sleeve is provided adjacent the tip-less teeth after winding of the conductors.

There is further provided a method of making such a composite powder metal stator sleeve in which a die is filled according to the pattern, followed by pressing the powder metal and sintering the compacted powder to achieve a high density composite powder metal stator sleeve of high structural stability. In another example of a method of the present invention, the powder metal materials are each mixed with a binder system to form feedstocks, the feedstocks are melted and concurrently or sequentially injected into a mold and allowed to solidify, and the solidified composite green compact is then subjected to binder removal and sintering processes to achieve a high density composite powder metal stator sleeve of high structural stability. In yet another example of a method of the present invention, the individual segments that comprise the stator sleeve are manufactured separately as green-state components, by either compaction or injection in a mold, then assembled adjacent each other in the desired pattern. A small amount of powder metal is provided at the boundaries between green segments, and the assembly is sinterbonded to achieve a high-density composite powder metal stator sleeve of high structural stability.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of a composite powder metal stator sleeve of the present invention having alternating magnetically conducting segments and magnetically non-conducting segments, the sleeve in surrounding relation to a rotor assembly.

FIG. 2 is a plan view of the stator sleeve of FIG. 1 positioned over the teeth of a stator core to provide stator tooth tips with radii.

FIG. 2A is a partial plan view of a stator sleeve of non-uniform thickness placed adjacent the teeth of a stator core with the magnetically non-conducting segments extending into the slots of the stator core.

FIG. 3 is a plan view of the stator sleeve of FIG. 1 further comprising surface grooves.

FIG. 4 is a plan view of a stator sleeve in surrounding relation to a rotor assembly and positioned over the teeth of a stator core to provide angular stator tooth tips.

FIG. 5 is a partial plan view of a stator sleeve positioned over the teeth of a stator core to provide a thin ring of uniform stator tooth tips.

FIG. 6 is a perspective view of an insert for use in a compaction-sintering method of the present invention.

FIG. 7 is a perspective view of an inner bowl and outer bowl of a hopper that may be used for filling the insert of FIG. 6.

FIGS. 8A-8E are cross-sectional schematic views of a method of the present invention using the insert of FIG. 6 and the hopper of FIG. 7 to produce the stator sleeve of FIG. 3.

FIGS. 9-10 are schematic views of embodiments of a molding step in a metal injection molding process in accordance with the present invention.

FIG. 11 is a partially exploded plan view of a partially assembled stator sleeve of FIG. 4 prior to sinterbonding.

FIG. 11A is an enlarged view of encircled area 11A of FIG. 11.

### DETAILED DESCRIPTION

The present invention provides composite powder metal stator sleeves for stator assemblies in electric machines, such as belt-driven alternators, starter-motor alternators, propulsion motors, machine tools, centrifuges, and automotive and non-automotive motors and generators. The composite powder metal sleeves enable use of conventional laminated stator cores with a simple, tip-less tooth configuration, while providing high or maximum slot fill to thereby provide high thermal heat dissipation and low current density. To this end, a sintered powder metal sleeve is fabricated to comprise alternating magnetically conducting segments and magnetically non-conducting segments. The two powder materials are joined together via a press and sinter operation, an injection molding operation or a sinterbonding operation into an annulus, thus forming a cylindrical shape that fits over the stator's teeth. The sleeve not only provides a magnetically conducting (permeable) material as an extension of the stator teeth, it also provides the tooth tips and topsticks thereby allowing for an unparalleled ease of winding insertion and the highest possible slot fill while retaining traditional stator performance. The tooth tip portions of the sleeve can be patterned exactly after standard tooth tips or any other desired shape, and can be varied to provide different stator assemblies while using a single tip-less stator core configuration. Also, grooves may be slit into the sleeve surface so as to face the air gap to reduce eddy currents formed by air gap fluctuations, if necessary.

The magnetically conducting segments comprise a sintered ferromagnetic powder metal, also referred to as a permeable or magnetic material. The ferromagnetic material may be soft ferromagnetic powder metal. In an embodiment of the present invention, the ferromagnetic powder metal is nickel, iron, cobalt or an alloy thereof. In another embodiment of the present invention, this ferromagnetic metal is a low carbon steel, a high purity iron powder with a minor addition of phosphorus, such as covered by MPIF (Metal Powder Industry Federation) Standard 35 F-0000, which contains approximately 0.27% phosphorus, or a silicon-iron powder, such as covered by MPIF Standard FS-0300, which is essentially Fe-3% Si. In general, AISI 400 series stainless steels are magnetically conducting, and may be used in the present invention.

The magnetically non-conducting segments comprise a sintered non-ferromagnetic powder metal, also referred to as non-permeable or non-magnetic material. In an embodiment of the present invention, the non-ferromagnetic powder metal is austenitic stainless steel, such as SS316. In general, the AISI 300 series stainless steels are non-magnetic and may be used in the present invention. Also, the AISI 8000 series steels are non-magnetic and may be used.

In an embodiment of the present invention, the ferromagnetic metal of the magnetically conducting segments and the non-ferromagnetic metal of the magnetically non-conducting segments are chosen so as to have similar densities and sintering temperatures, and are approximately of the same strength, such that upon compaction-sintering, injection molding or sinterbonding, the materials behave in a similar fashion. In an embodiment of the present invention, the ferromagnetic powder metal is Fe-0.27% P and the non-ferromagnetic powder metal is SS316.

The powder metal stator sleeves of the present invention typically exhibit magnetically conducting segments having at least about 95% of theoretical density, and typically between about 95%-98% of theoretical density. Wrought steel or iron has a theoretical density of about 7.85 gms/cm³, and thus, the magnetically conducting segments exhibit a density of around 7.46-7.69 gms/cm³. The non-conducting segments exhibit a density of at least about 85% of theoretical density, which is on the order of about 6.7 gms/cm³. Thus, the non-ferromagnetic powder metals are less compactable then the ferromagnetic powder metals.

The powder metal stator sleeves can essentially be of any thickness. The stator sleeve is placed adjacent the teeth of a conventional tip-less stator core of stamped laminations, or a powder metal tip-less stator core, and aligned with respect to the stator core such that the permeable material is generally aligned over the stator teeth. The stator sleeve of the present invention may be used with an inner rotor or an outer rotor. Several sleeves may be placed axially along the stator core to cover the entire length of the stator core, or may be of longer or shorter length than the stator core. The non-ferromagnetic powder metal of the stator sleeve acts as a topstick/slot wedge and a magnetic insulator between the stator teeth and increases the structural stability of the assembly.

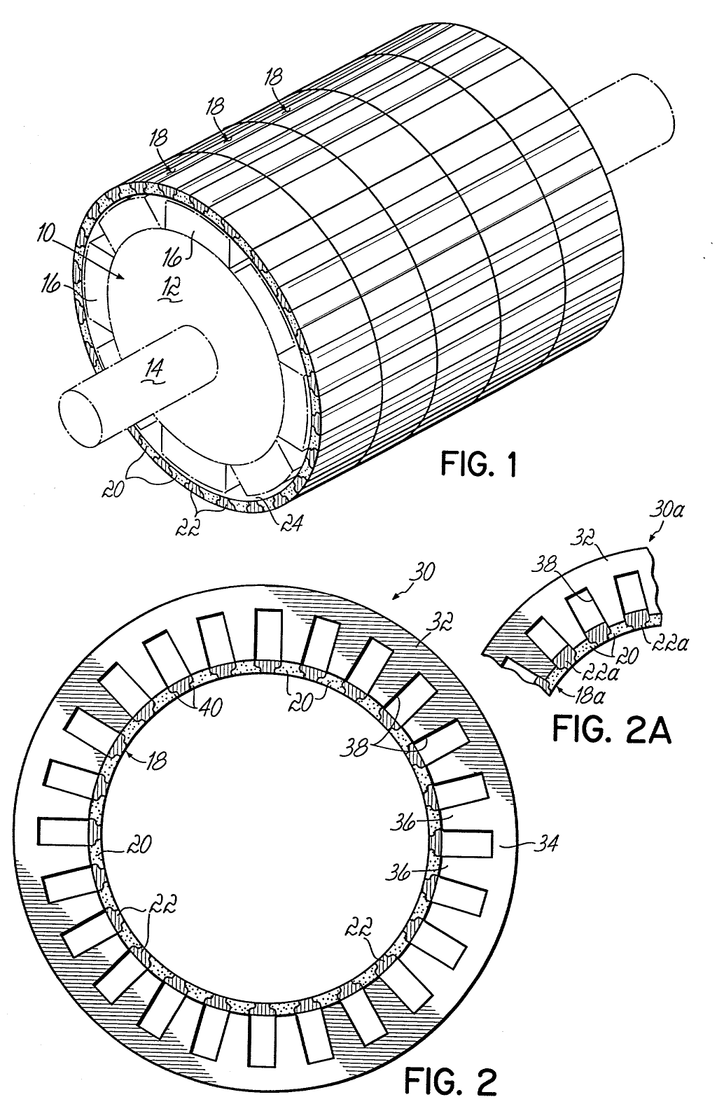

With reference to the figures in which like numerals are used throughout to represent like parts, FIG. 1 depicts in perspective view a surface permanent magnet inner rotor assembly 10, in phantom, having a rotor core 12, such as one comprising stamped laminations, attached to a shaft 14, and a plurality of alternating polarity permanent magnets 16 affixed to the rotor core 12. A plurality of annular composite powder metal stator sleeves 18 of the present invention circumferentially surround the permanent magnets 16, with an air gap 24 therebetween, the sleeves 18 each comprising magnetically conducting segments 20 in alternating relation with magnetically non-conducting segments 22.

FIG. 2 depicts in plan view a stator assembly 30 including stator sleeve 18 of FIG. 1. Assembly 30 includes a stator core 32 positioned around the stator sleeve 18, the stator core 32 including a back iron (yoke) 34 and a plurality of teeth 36 extending radially inward therefrom, with slots 38 between the teeth 36. The sleeves 18 are aligned with the teeth 36 such that the magnetically conducting segments 20 are generally aligned with the teeth 36 and the magnetically non-conducting segments 22 are generally aligned with the slots 38, in between the teeth 36. The magnetically conducting segments 20 are shaped to correspond to a desired tooth tip configuration, such as tooth tips with radii 40, as shown in FIGS. 1 and 2. Thus, the sleeve 18 provides a stator assembly 30 having a core back iron 34 with stator teeth 36 including permeable powder metal tooth tips 20 as an extension thereof. The sleeve 18 further provides a stator assembly 30 having built-in non-permeable topsticks/slot wedges 22 between the permeable tooth tips 20 enclosing the slots 38 adjacent the air gap 24. Because the topsticks/slot wedges are an integral part of the sleeve 18, separate installation of topsticks/slot wedges is unnecessary after winding insertion.

FIG. 2A depicts in partial plan view a stator assembly 30a, including the stator core 32 of FIG. 2 and a composite powder metal stator sleeve 18a of non-uniform thickness. Stator sleeve 18a includes thicker magnetically non-conducting segments 22a that extend inwardly into slots 38 between the thinner magnetically conducting segments 20. This embodiment may be useful for holding the conductors (not shown) securely in place in the slots 38 where the conductors don't completely fill the slots 38.

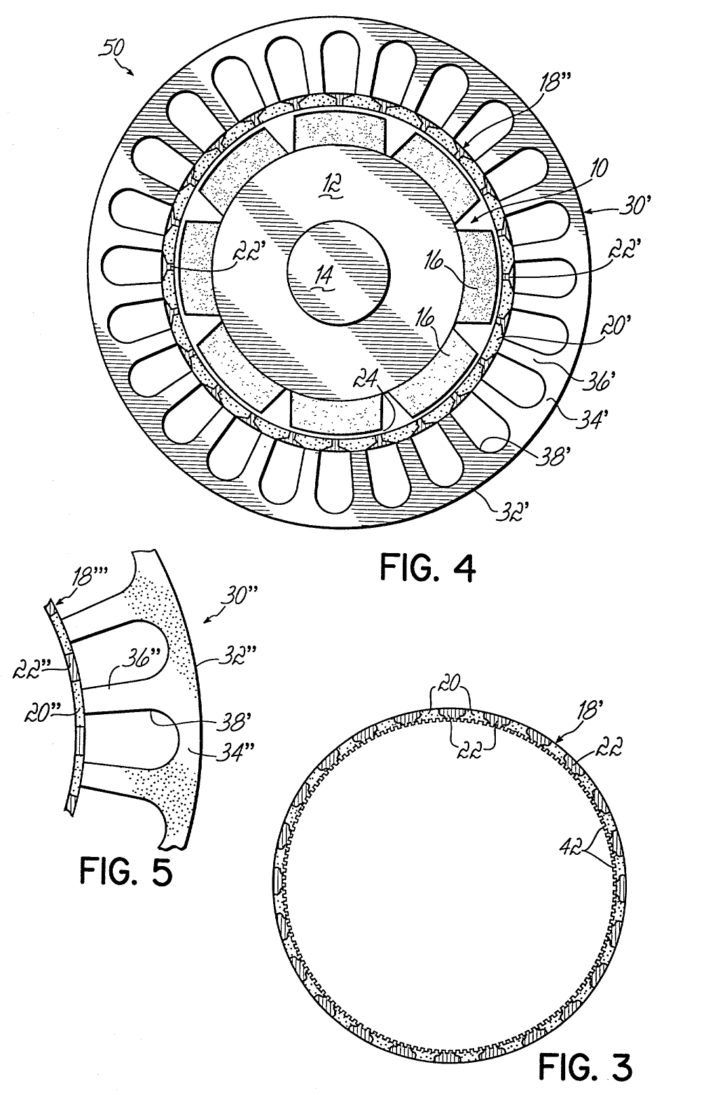

FIG. 3 depicts a stator sleeve 18′ similar in configuration to that depicted in FIGS. 1 and 2, but which includes grooves 42 around the interior of stator sleeve 18′ on both the magnetically conducting segments 20 and magnetically non-conducting segments 22. Grooves 42 may be slit into the interior sleeve surface so as to face the air gap 24 to reduce eddy currents formed by air gap fluctuations, if necessary.

FIG. 4 depicts in plan view a rotor-stator assembly 50 of the present invention including the inner rotor assembly 10 of FIG. 1 having a rotor core 12 attached to a shaft 14 with a plurality of surface permanent magnets 16 extending radially outward. A stator assembly 30′ is provided adjacent the rotor assembly 10, in surrounding relation, and includes a traditional stator core 32′ with a back iron 34′ and tip-less teeth 36′ formed, for example, from stamped laminations. Annular composite powder metal sleeves 18″ of the present invention are placed adjacent the teeth 36′ and surround the permanent magnets 16 of rotor core 12, adjacent the air gap 24. Each sleeve 18″ comprises magnetically conducting segments 20′ which form the tips of the teeth 36′ in alternating relation with magnetically non-conducting segments 22′ which form topsticks/slot wedges between the tooth tips 20′. In this embodiment, the magnetically conducting segments 20′ are angled to provide angular tooth tips 20′. Thus, the sleeves 18″ are aligned with the stator core 32′ such that the magnetically conducting segments 20′ are generally aligned with the teeth 36′ and the magnetically non-conducting segments 22′ are generally in between the teeth 36′ and generally aligned with the slots 38′.

FIG. 5 depicts in partial plan view a stator assembly 30″ of the present invention having a powder metal stator core 32″ similar to core 32′ of FIG. 4 with a back iron 34″ and tip-less teeth 36″. A thin annular composite powder metal sleeve 18′″ of the present invention is placed adjacent and contacting the teeth 36″ of the stator core 32″. The sleeve 18′″ comprises magnetically conducting segments 20″ in alternating relation with magnetically non-conducting segments 22″ to form uniform tooth tips 20″ with thin intermediate topsticks/slot wedges 22″. The sleeves 18′″ are aligned with the stator core 32″ such that the magnetically non-conducting segments 22″ are generally aligned with the slots 38′ and the magnetically conducting segments 20″ are generally aligned with the teeth 36″. Higher slot fill may be achieved by using the tip-less powder metal stator core 32″ with the powder metal sleeve 18′″ of the present invention.

While FIGS. 1-5 depict various embodiments of stator assemblies, it should be appreciated that numerous other embodiments exist, including those having a varying number of tooth tips, and having various sizes of components. For example, the stator sleeves of the present invention may be used in rotor/stator assemblies having an outer rotor and an inner stator core with the teeth of the stator core extending radially outward from the back iron. The particular embodiments were provided for purposes of explaining representative applications for the composite powder metal stator sleeve of the present invention. Thus, the invention should not be limited to the particular embodiments shown in FIGS. 1-5.

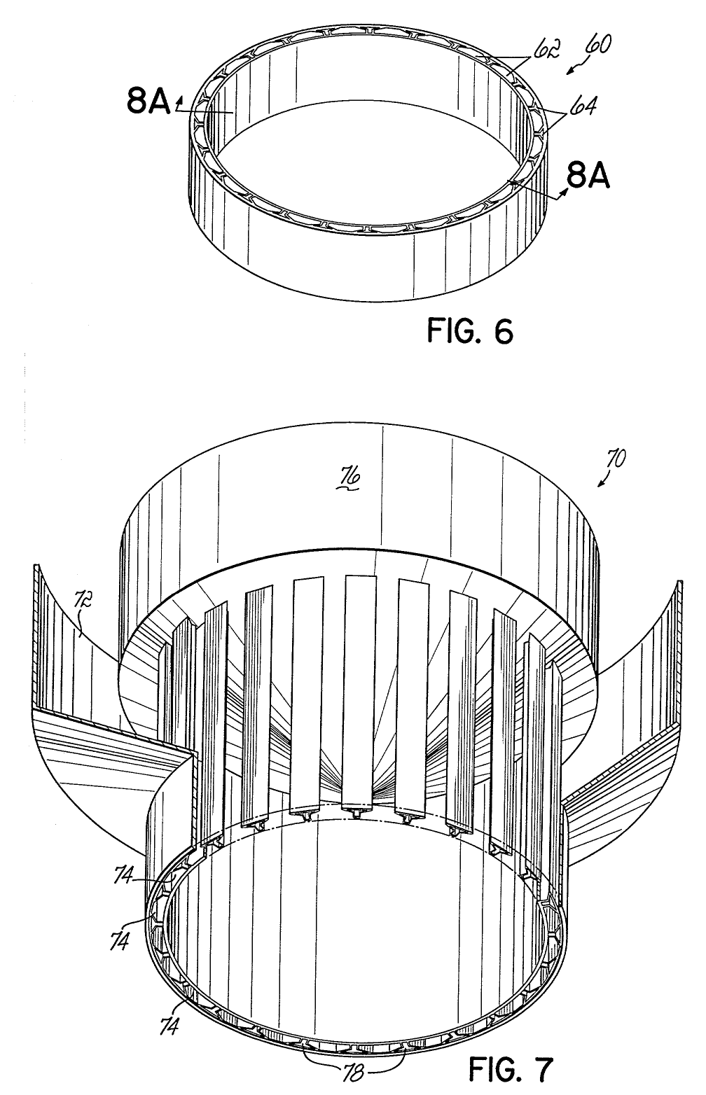

The present invention further provides methods for fabricating composite powder metal sleeves 18 for assembling with a stator core 32 to form an electric machine. To this end, one method comprises a compaction-sintering operation. A ring-shaped die 60 is provided having discrete regions in a pattern corresponding to the desired stator sleeve magnetic configuration, as best shown in FIG. 6, which will be discussed in more detail below. Alternating regions of the die 60 are filled with a ferromagnetic powder metal to ultimately form the magnetically conducting segments 20′ of the stator sleeve 18″ depicted in FIG. 4. The other alternating discrete regions of the die 60 are filled with non-ferromagnetic powder metal to ultimately form the magnetically non-conducting segments 22′ of the stator sleeve 18″. The powder metals are pressed in the die 60 to form a compacted powder metal ring, also referred to as a green-strength compact. This compacted powder metal is then sintered to form a powder metal sleeve 18″ having alternating regions of magnetically conducting material 20′ and magnetically non-conducting material 22′, the sleeve 18″ exhibiting high structural stability. The pressing and sintering process results in magnetically conducting segments 20′ having a density of at least 95% of theoretical density, and magnetically non-conducting segments 22′ having a density of at least about 85% of theoretical density. One or a plurality of sleeves 18″ are then placed adjacent a stator core 32′ to form a stator assembly 30′ as in FIG. 4. The method for forming these stator assemblies provides increased mechanical integrity, increased slot fill, lower rotor eddy current losses, efficient flux channeling, reduced cost and simpler construction.

In one embodiment of the compaction-sintering method of the present invention, the regions in the die 60 are filled concurrently with the two powder metals, which are then concurrently pressed and sintered. In another embodiment of the method of the present invention, the regions are filled sequentially with the powder metal being pressed and then sintered after each filling step. In other words, one powder metal is filled into alternating regions of the die 60, pressed and sintered, and then the second powder metal is filled into the other alternating regions and the entire assembly is pressed and sintered.

The pressing of the filled powder metal may be accomplished by uniaxially pressing the powder in a die 60, for example at a pressure of about 45-50 tsi. It should be understood that the pressure needed is dependent upon the particular powder metal materials that are chosen. In a further embodiment of the present invention, the pressing of the powder metal involves heating the die 60 to a temperature in the range of about 275° F. (135° C.) to about 290° F. (143° C.), and heating the powders within the die 60 to a temperature in the range of about 175° F. (79° C.) to about 225° F. (107° C.).

The sintering of the pressed powder comprises heating the compacted powder metal to a first temperature of about 1400° F. (760° C.) and holding at that temperature for about one hour. Generally, the powder metal includes a lubricating material, such as a plastic, on the particles to increase the strength of the material during compaction. The internal lubricant reduces particle-to-particle friction, thus allowing the compacted powder to achieve a higher strength after sintering. The lubricant is then burned out of the composite during this initial sintering operation, also known as a delubrication or delubing step. A delubing for one hour is a generally standard practice in the industry and it should be appreciated that times above or below one hour are sufficient for the purposes of the present invention if delubrication is achieved thereby. Likewise, the temperature may be varied from the general industry standard if the ultimate delubing function is performed thereby. After delubing, the sintering temperature is raised to a full sintering temperature, which is generally in the industry about 2050° F. (1121° C.). During this full sintering, the compacted powder shrinks, and particle-to-particle bonds are formed, generally between iron particles. Standard industry practice involves full sintering for a period of one hour, but it should be understood that the sintering time and temperature may be adjusted as necessary. The sintering operation may be performed in a vacuum furnace, and the furnace may be filled with a controlled atmosphere, such as argon, nitrogen, hydrogen or combinations thereof. Alternatively, the sintering process may be performed in a continuous belt furnace, which is also generally provided with a controlled atmosphere, for example a hydrogen/nitrogen atmosphere such as 75% H₂/25% N₂. Other types of furnaces and furnace atmospheres may be used within the scope of the present invention as determined by one skilled in the art.

For the purposes of illustrating the compaction-sintering method of the present invention, FIGS. 6-8E depict die inserts, hopper configurations and pressing techniques that may be used to achieve the concurrent filling or sequential filling of the powder metals and subsequent compaction to form the composite powder metal stator sleeves of the present invention. It is to be understood, however, that these illustrations are merely examples of possible methods for carrying out the present invention.

FIG. 6 depicts a die insert 60 that may be placed within a die cavity to produce the powder metal sleeve 18″ of FIG. 4. The two powder metals, i.e. the ferromagnetic and non-ferromagnetic powder metals, are filled concurrently or sequentially into the separate insert cavities 62, 64, and then the insert 60 is removed. By way of example only, FIG. 7 depicts a hopper assembly 70 that may be used to fill the insert 60 of FIG. 6 with the powder metals. In this assembly 70, an outer bowl 72 is provided having a plurality of tubes 74 corresponding to cavities 62 of die insert 60 for forming the magnetically conducting segments 20′ of the stator sleeve 18″ of FIG. 4. This outer bowl 72 is adapted to hold and deliver the ferromagnetic powder metal. An inner bowl 76 is positioned within the outer bowl 72, with a plurality of tubes 78 corresponding to cavities 64 of die insert 60 for forming the magnetically non-conducting segments 22′ of the stator sleeve 18″. This inner bowl 76 is adapted to hold and deliver non-ferromagnetic powder metal. This dual hopper assembly 70 enables either concurrent or sequential filling of the die insert 60 of FIG. 6.

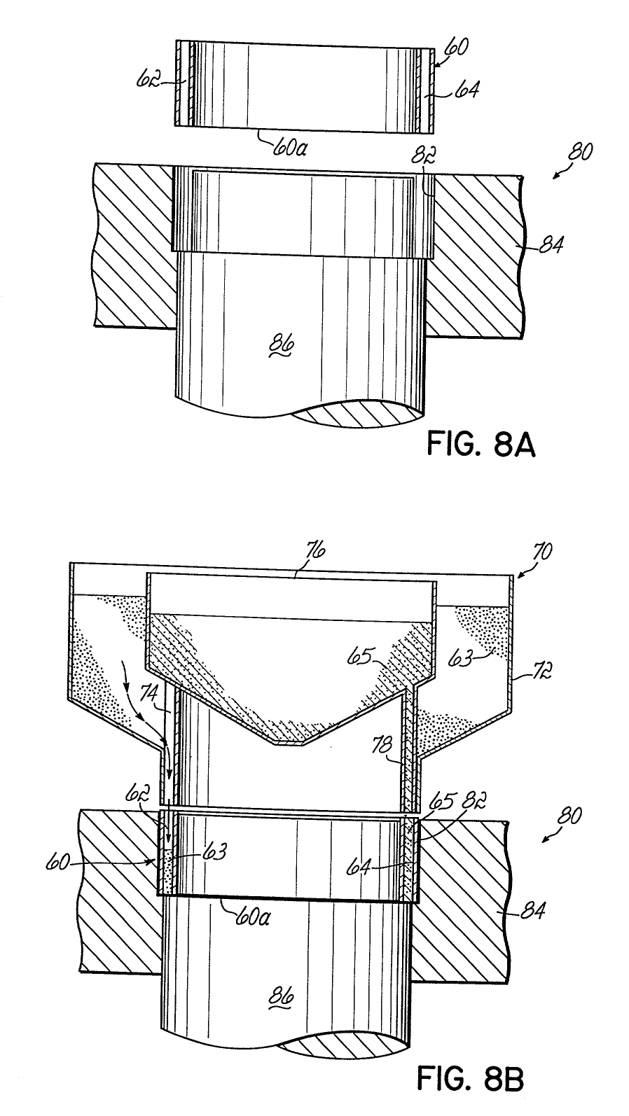

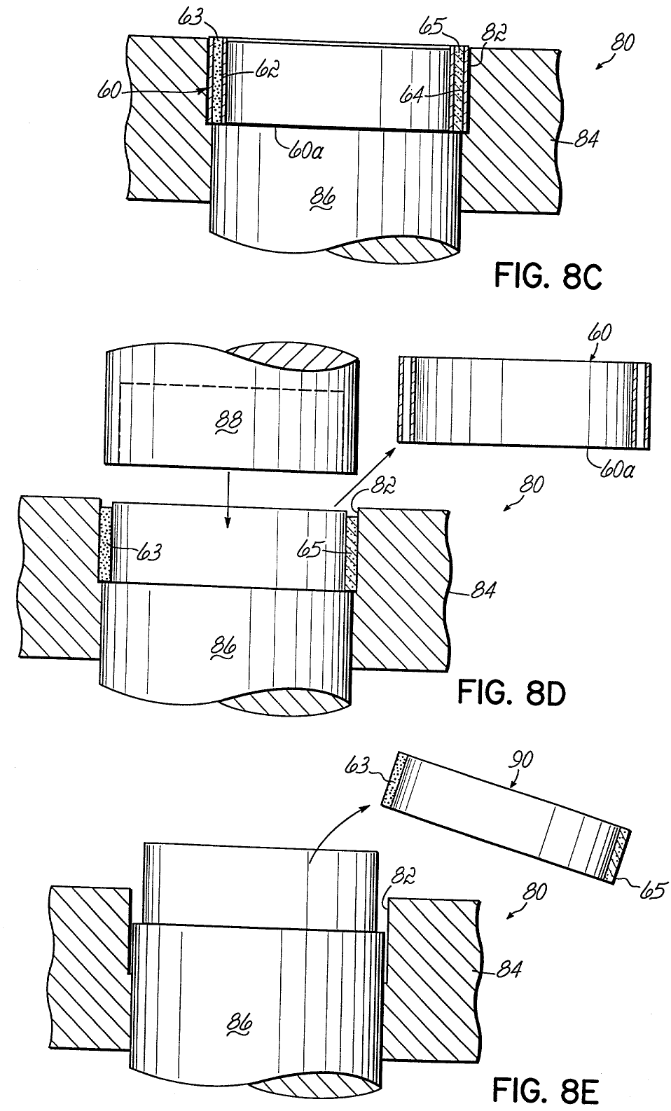

FIGS. 8A-8E depict schematic views in partial cross-section taken along line 8A-8A of FIG. 6 of how the die insert 60 of FIG. 6 and the hopper assembly 70 of FIG. 7 can be used with a uniaxial die press 80 to produce the composite powder metal stator sleeve 18″ of FIG. 4. In this method, the die insert 60 is placed within a cavity 82 in the die 84, as shown in FIG. 8A, with a lower punch 86 of the press 80 abutting the bottom 60a of the insert 60. The hopper assembly 70 is placed over the insert 60 and the powder metals 63, 65 are filled into the insert cavities 62, 64, concurrently or sequentially, as shown in FIG. 8B. The hopper assembly 70 is then removed, leaving a filled insert 60 in the die cavity 82, as shown in FIG. 8C. Then the insert 60 is lifted out of the die cavity 82, which causes some settling of the powder, as seen in FIG. 8D. The upper punch 88 of the press 80 is then lowered down upon the powder-filled die cavity 82, as shown by the arrow in FIG. 8D, to uniaxially press the powders in the die cavity 82. The final composite part 90, or green-strength compact, is then ejected from the die cavity 82 by raising the lower punch 86. The part 90 is next transferred to a sintering furnace (not shown). Where the filling is sequential, the first powder is poured into either the outer bowl 72 or inner bowl 76, and a specially configured upper punch 88 is lowered so as to press the filled powder, and the partially filled and compacted insert (not shown) is sintered. The second fill is then effected and the insert 60 removed for pressing, ejection and sintering of the complete green-strength compact 90. Additional variations on the compaction-sintering process may be found in the above-cited co-pending application Ser. Nos. 09/970,230, 09/970,197, 09/970,223, 09/970,105, and 09/970,106.

Another method of the present invention for forming the stator sleeve 18″ is metal injection molding (MINI). The general process for injection molding includes selecting the two powder materials and the binder system for the particular stator sleeve to be molded. The powders are each blended or mixed together with binder and granulated or pelletized to provide the feedstocks for the subsequent molding process. The powder material is mixed with the binder system to hold the powder material together prior to injection molding. The binder or carrier may be, for example, a plastic, wax, water or any other suitable binder system used for metal injection molding. By way of further example, the binder system may include a thermoplastic resin, including acrylic polyethylene, polypropylene, polystyrene, polyvinyl chloride, polyethylene carbonate, polyethylene glycol, and polybutyl methacrylate. Non-restrictive examples of waxes include bees, Japan, montan, synthetic, microcrystalline and paraffin waxes. The binder system may also contain, if necessary, plasticizers, such as dioctyl phthalate, diethyl phthalate, di-n-butyl phthalate and diheptyl phthalate. Generally, a feedstock for metal injection molding will contain a binder system in an amount up to about 70% by volume, with about 30-50% being most common.

For the molding process, each feedstock is heated to a temperature sufficient to allow the mixture's injection through an injection unit. Although some materials may be injected at temperatures as low as room temperature, the mixtures are typically heated to a temperature between about 85° F. (29° C.) to about 385° F. (196° C.). The melted feedstocks are then injected into a mold, either sequentially or concurrently, under moderate pressure (i.e., less than about 10,000 psi) and allowed to solidify to form a green-strength compact. The green-strength compact is then ejected from the mold. The melting and injection are typically conducted in an inert gas atmosphere, such as argon, nitrogen, hydrogen and helium. The rates of injection are not critical to the invention, and can be determined by one skilled in the art in accordance with the compositions of each feedstock. Different injection units may be used for each feedstock to avoid cross-contamination where such contamination should be avoided.

Following ejection of the parts from the mold, the molded parts are debinded to remove the binder material. Debinding processes are well known to those skilled in the art of powder metallurgy, and are described in detail in the above-cited co-pending application Ser. No. 09/970,226. By way of example, one general practice in the industry for thermal debinding of an MIM part includes heating to a temperature in the range of about 212° F. (100° C.) to about 1562° F. (850° C.), typically about 1400° F. (760° C.), and holding at that temperature for less than about 6 hours, typically about 1-2 hours, to burn off the binder material.

The composite part is then subjected to a sintering process, which is also well known to those skilled in art of powder metallurgy. The sintering step typically comprises raising the temperature from the debinding step to a higher temperature in the range of about 1742° F. (950° C.) to about 3272° F. (1800° C.), typically about 2050° F. (1121° C.), and holding at that temperature for less than about 6 hours, typically about 1-2 hours. Sintering achieves densification chiefly by formation of particle-to-particle binding, thereby forming a high-density, coherent mass of two or more materials with clear, well-defined boundaries therebetween. Densities approaching full theoretical density are possible in the composite MIM parts of the present invention, generally up to about 99% of theoretical.

It should be understood that dissimilar materials behave differently during injection and solidification, such that the dissimilar materials should be selected or manipulated to have similar shrinkage ratios, as well as compatible binder removal and sintering cycles to minimize defects in the final product, where such defects would render the part unacceptable for its purpose. By way of example only, particle size, particle size distribution, particle shape and purity of the powder material can be selected or manipulated to affect such properties or parameters as apparent density, green strength, compressibility, sintering time and sintering temperature. The amount and type of binder mixed with each powder material may also affect various properties of the feedstock, green compact and sintered component, and various process parameters. The method for forming the powder materials, including mechanical, chemical, electrochemical and atomizing processes, also can affect the performance of the powder material during the injection molding process.

The mold is designed according to the pattern desired for the composite stator sleeve. Molds for metal injection molding are advantageously comprised of a hard material, such as steel, so as to withstand abrasion from the powder materials. Sliding cores, ejectors, and other moving components can be incorporated in the mold when necessary to form the different material regions of the composite sleeve. Thus, the mold is created to have a plurality of cavities into which the feedstocks are injected. The cavities correspond to the particular design needed for the desired machine type. The overall mold is generally annular, which corresponds to the general shape of a stator sleeve for mounting over the teeth of a stator core to form a stator assembly of an electric machine. Stator sleeves that require geometries and material boundaries that are intricate, such as the angular tooth tips 20′ for the stator sleeve 18″ of FIG. 4, are advantageously fabricated by MIM such that the tight tolerances achievable in injection molding can enable manufacture of a superior, high density intricate stator sleeve.

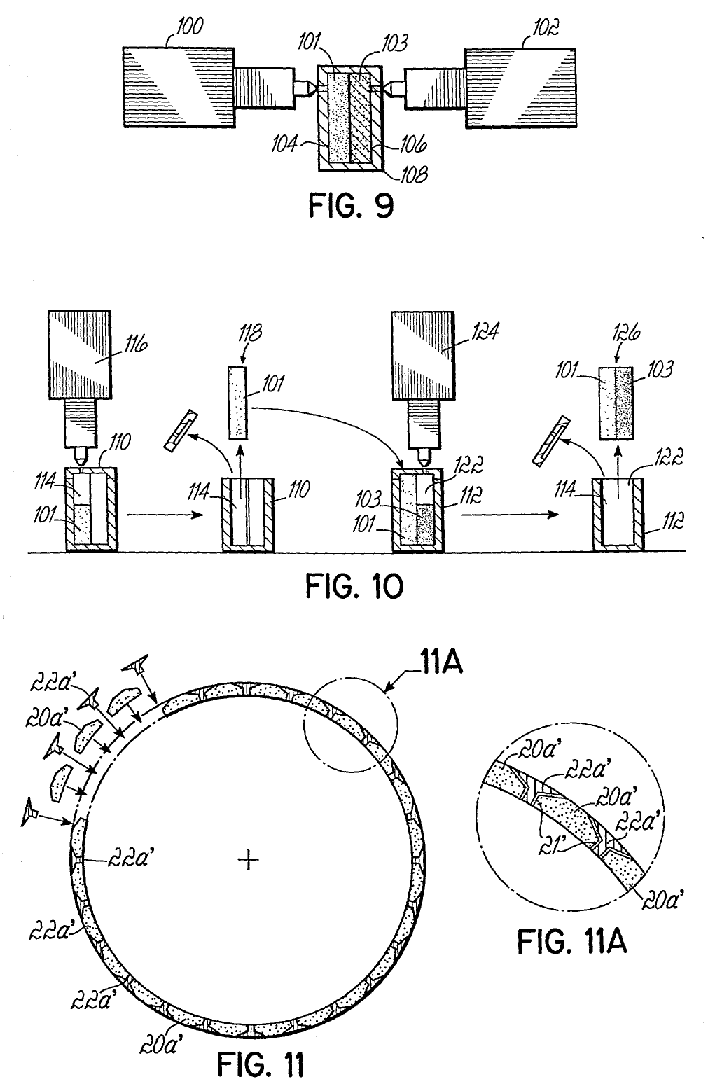

Referring further to the Figures to illustrate the MIM method of the present invention, FIG. 9 depicts one embodiment of the present invention utilizing a single molding machine (not shown) having two injection units 100, 102 for filling respective alternating cavities 104, 106 of a single mold 108 with two dissimilar materials 101, 103, specifically ferromagnetic and non-ferromagnetic powder metals. As stated above, the mold is generally annularly shaped, which corresponds to the general shape of a stator sleeve. The injection units 100, 102 may be stationary during the injection process with the mold rotated to fill the cavities 104, 106, or the injection units 100, 102 may be rotated or moved to inject the two materials 101, 103 concurrently or sequentially to form the composite green-strength part. Once all of the materials have been injected and have been allowed to solidify, the mold 108 is opened and the part ejected therefrom. The part may then be subjected to known binder removal and sintering processes to form a final high-density composite part.

FIG. 10 depicts an alternative embodiment of the MIM method of the present invention. In this embodiment, multiple molds 110, 112 are used to inject each of the two materials 101, 103 independently or sequentially. A first material or melted feedstock 101 is injected into alternating cavities 114 in the first mold 110 by an injection unit 116 to form the proper shape. For purposes of simplicity of depiction, each mold 110, 112 shown in FIG. 10 has two cavities 114, 122, each cavity receiving a different material, for forming a two-material composite part. It is to be understood, however, that the first feedstock 101 may be injected into a plurality of cavities 114, and the second feedstock 103 may be injected into a plurality of cavities 122 to form a composite stator sleeve of alternating materials. After the first material 101 is injected, and allowed to solidify, the partially formed part 118 is then ejected and placed into a second mold 112. A second dissimilar material 103 is injected into another cavity 122 in mold 112, either by a second injection unit 124 from the same single machine (not shown), or by an injection unit 124 of a second machine (not shown). After the second material 103 is allowed to solidify, the complete molded part 126, or green-strength compact, is ejected from the second mold 112, and the compact 126 is debinded and sintered. Additional variations in the MIM process may be found in the above-cited co-pending application Ser. No. 09/970,226.

Another method of the present invention for forming the stator sleeve 18″ is sinterbonding, which is described in further detail in the context of rotor core formation in co-pending U.S. patent application Ser. No. ______ filed on even date herewith and entitled “Sinterbonded Electric Machine Components” which is incorporated by reference herein it is entirety. The ferromagnetic and non-ferromagnetic powder metals are pressed separately in individual dies to form compacted powder metal segments 20a′, 22a′, or green-strength segments, as shown in FIG. 11. The compacted powder metal segments 20a′, 22a′ are then positioned adjacent to each other in the desired magnetic pattern as indicated by the arrows. A small amount of powder metal 21′ is then provided between the green-strength segments 20a′, 22a′, as depicted in FIG. 11A, which is an enlarged view of a portion of FIG. 11, and the arrangement is then sintered to form a sinterbonded powder metal stator sleeve 18″ having alternating regions of magnetically non-conducting material 22′ and magnetically conducting material 20′, as shown in FIG. 4, the component exhibiting high structural stability and definitive boundaries between regions.

The small amount of powder material 21′, such as high purity iron powder, facilitates bond formation between the separate green-strength segments 20a′, 22a′ during sintering. The amount of powder metal 21′ provided between green-strength segments 20a′, 22a′ may be any amount deemed necessary or adequate for a bond to form between the segments. In an embodiment of the present invention, the small amount of powder metal 21′ added between the green-strength segments 20a′, 22a′ is a soft ferromagnetic material, such as described above. For example, the small amount of added powder metal 21′ may be high purity iron powder, such as covered by MPIF Standard 35 F-0000. In another embodiment of the present invention, the small amount of added powder metal 21′ is the same powder metal as used to form the magnetically conducting segments 20′ of the stator sleeve 18″. Alternatively, the small amount of added powder metal 21′ may be a non-ferromagnetic material, such as described above. For example, the small amount of added powder metal 21′ may be an austenitic stainless steel, such as SS316. In yet another embodiment of the present invention, the small amount of added powder metal 21′ is the same powder metal as used to form the magnetically non-conducting segments 22′ of the stator sleeve 18″.

The pressing or compaction of the filled powder metal to form the green-strength segments 20a′, 22a′ and the subsequent debinding and full sintering may be accomplished as described above for the compaction-sintering method or by the MIM method. Additional variations in the sinterbonding process may be found in co-pending application Ser. No. ______ filed on even date herewith and entitled “Sinterbonded Electric Machine Components.”

Composite powder metal stator sleeves, whether they are compacted or injection-molded as described in the co-pending applications referred to above or whether they are sinterbonded, may be used in conjunction with traditional stamped electric machine stator cores to provide a strength and performance advantage over sleeveless cores. Composite powder metal sleeves add strength to the traditional stamped electric machine stator cores because they may utilize non-permeable material, for example stainless steel, to add structural stability while allowing open slots for maximum slot fill and incorporating built-in topsticks/slot wedges and tooth tips to the assembly. Thus, the addition of composite powder metal sleeves of the present invention produces electric machine stator components that are stronger, have better thermal heat dissipation and have lower current density than those comprising only the core of stamped laminations.

While the present invention has been illustrated by the description of embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the scope or spirit of applicant's general inventive concept.

What is claimed is:

1. An annular composite powder metal stator sleeve for placing over tipless teeth of an annular stator core, the sleeve comprising a plurality of magnetically conducting segments of sintered ferromagnetic powder metal in alternating relation with a plurality of magnetically non-conducting segments of sintered non-ferromagnetic powder metal to form the annular composite powder metal stator sleeve, wherein the magnetically conducting segments have a shape corresponding to a desired tooth tip-shape, for forming tooth tips when placed over the teeth of the stator core.

2. The sleeve of claim 1 wherein the ferromagnetic powder metal is Ni, Fe, Co or an alloy thereof.

3. The sleeve of claim 1 wherein the ferromagnetic powder metal is a high purity iron powder with a minor addition of phosphorus.

4. The sleeve of claim 1 wherein the non-ferromagnetic powder metal is an austenitic stainless steel.

5. The sleeve of claim 1 wherein the non-ferromagnetic powder metal is an AISI 8000 series steel.

6. A powder metal stator assembly for an electric machine, comprising:
a stator core comprising a back iron and a plurality of tip-less teeth extending radially therefrom;
at least one composite powder metal sleeve over the teeth, the at least one sleeve comprising a plurality of magnetically conducting segments of sintered ferromagnetic powder metal in alternating relation with a plurality of magnetically non-conducting segments of sintered non-ferromagnetic powder metal, each magnetically conducting segment being generally aligned with a corresponding tooth of the stator core to thereby form tooth tips extending from the plurality of teeth.

7. The assembly of claim 6 wherein the ferromagnetic powder metal is Ni, Fe, Co or an alloy thereof.

8. The assembly of claim 6 wherein the ferromagnetic powder metal is a high purity iron powder with a minor addition of phosphorus.

9. The assembly of claim 6 wherein the non-ferromagnetic powder metal is an austenitic stainless steel.

10. The assembly of claim 6 wherein the non-ferromagnetic powder metal is an AISI 8000 series steel.

11. A method of making an annular composite powder metal stator sleeve for placing over an annular stator core having a plurality of tip-less teeth, the sleeve comprising a plurality of tooth tip-shaped magnetically conducting segments in alternating relation with a plurality of magnetically non-conducting segments, the method comprising:
placing a plurality of green-strength magnetically conducting segments adjacent a plurality of green-strength magnetically non-conducting segments in alternating relation to form a ring;
adding powder metal between the segments; and
sintering the segments and added powder metal whereby the segments are bonded together by the added powder metal to form the annular composite powder metal stator sleeve.

12. The method of claim 11 further comprising forming the plurality of green-strength magnetically conducting segments by pressing a ferromagnetic powder metal and forming the plurality of green-strength magnetically non-conducting segments by pressing a non-ferromagnetic powder metal.

13. The method of claim 12 wherein the added powder metal is the ferromagnetic powder metal.

14. The method of claim 12 wherein the added powder metal is the non-ferromagnetic powder metal.

15. The method of claim 12 wherein the ferromagnetic powder metal is Ni, Fe, Co or an alloy thereof.

16. The method of claim 12 wherein the ferromagnetic powder metal is a high purity iron powder with a minor addition of phosphorus.

17. The method of claim 12 wherein the non-ferromagnetic powder metal is an austenitic stainless steel.

18. The method of claim 12 wherein the non-ferromagnetic powder metal is an AISI 8000 series steel.

19. The method of claim 12 wherein pressing comprises uniaxially pressing the powder in a die.

20. The method of claim 19 wherein pressing comprises pre-heating the powder and pre-heating the die.

21. The method of claim 11 wherein the added powder metal comprises a magnetically conducting material.

22. The method of claim 11 wherein the added powder metal comprises a magnetically non-conducting material.

23. The method of claim 11 wherein sintering includes delubricating the segments by heating to a first temperature, followed by fully sintering the segments by heating to a second temperature greater than the first temperature.

24. The method of claim 11 further comprising placing a plurality of the composite powder metal sleeves adjacent the stator core, with the magnetically conducting segments of the sleeves generally aligned with the respective tip-less teeth to form a plurality of tooth tips extending from the teeth of the stator core, to form a stator assembly for an electric machine.

25. A method of making an annular composite powder metal stator sleeve for placing over an annular stator core having a plurality of tip-less teeth, the sleeve comprising a plurality of tooth tip-shaped magnetically conducting segments in alternating relation with a plurality of magnetically non-conducting segments, the method comprising:
filling a plurality of first regions in a ring-shaped die with a ferromagnetic powder metal;
filling a plurality of second regions in the die with a non-ferromagnetic powder metal, the second regions in alternating relation with the first regions;
pressing the powders in the die to form a compacted powder metal ring; and
sintering the compacted powder metal ring to form the annular composite powder metal stator sleeve.

26. The method of claim 25 wherein the first and second regions are filled concurrently.

27. The method of claim 25 wherein the first and second regions are filled sequentially with the powder metal being pressed and sintered after each filling step.

28. The method of claim 25 wherein the ferromagnetic powder metal is Ni, Fe, Co or an alloy thereof.

29. The method of claim 25 wherein the ferromagnetic powder metal is a high purity iron powder with a minor addition of phosphorus.

30. The method of claim 25, wherein the non-ferromagnetic powder metal is an austenitic stainless steel.

31. The method of claim 25, wherein the non-ferromagnetic powder metal is an AISI 8000 series steel.

32. The method of claim 25, wherein the pressing comprises uniaxially pressing the powders in the die.

33. The method of claim 32, wherein the pressing comprises pre-heating the powders and pre-heating the die.

34. The method of claim 25, wherein, after the pressing, the compacted powder metal ring is de-lubricated at a first temperature, followed by sintering at a second temperature greater than the first temperature.

35. The method of claim 25 further comprising placing a plurality of the composite powder metal sleeves adjacent the stator core, with the magnetically conducting segments of the sleeves generally aligned with the respective tip-less teeth to form a plurality of tooth tips extending from the teeth of the stator core, to form a stator assembly for an electric machine.

36. A method of making an annular composite powder metal stator sleeve for placing over an annular stator core having a plurality of tip-less teeth, the sleeve comprising a plurality of tooth tip-shaped magnetically conducting segments in alternating relation with a plurality of magnetically non-conducting segments, the method comprising:
injecting a ferromagnetic powder material from a first injection unit under heat and pressure into a plurality of first mold cavities in a ring-shaped mold, and allowing the ferromagnetic material to solidify;
injecting a non-ferromagnetic powder material from a second injection unit under heat and pressure into a plurality of second mold cavities in the mold, the second mold cavities in alternating relation with the first mold cavities, and allowing the non-ferromagnetic material to solidify to thereby produce a composite injection molded green-strength ring; and
sintering the composite ring.

37. The method of claim 36 further comprising, prior to sintering, ejecting the green-strength ring from the mold and subjecting the green-strength ring to debinding to provide a composite ring that is essentially free of binder.

38. The method of claim 36 wherein the ferromagnetic and non-ferromagnetic powder materials are injected concurrently.

39. The method of claim 36 wherein the ferromagnetic and non-ferromagnetic powder materials are injected sequentially.

40. The method of claim 36, wherein the ferromagnetic powder material is a soft ferromagnetic powder metal selected from the group consisting of Ni, Fe, Co and alloys thereof.

41. The method of claim 36, wherein the ferromagnetic powder material is a soft ferromagnetic high purity iron powder with a minor addition of phosphorus.

42. The method of claim 36, wherein the non-ferromagnetic powder material is an austenitic stainless steel.

43. The method of claim 36, wherein the non-ferromagnetic powder material is an AISI 8000 series steel.

44. The method of claim 36, wherein the ferromagnetic and non-ferromagnetic powder materials are each combined with a binder prior to injecting.

45. The method of claim 36 further comprising placing a plurality of the composite powder metal sleeves adjacent the stator core, with the magnetically conducting segments of the sleeves generally aligned with the respective tip-less teeth to form a plurality of tooth tips extending from the teeth of the stator core, to form a stator assembly for an electric machine.
